(19) United States
(12) Patent Application Publication
(10) Pub. No.: US 2010/0215859 A1
(43) Pub. Date: Aug. 26, 2010

(54) Portable dip-coating system for applying liquid coating materials, and related methods

(76) Inventor: David Lee Alexander, Seattle, WA (US)

Correspondence Address: Janeway Patent Law PLLC, SUITE 508, 2208 NW MARKET STREET, Seattle, WA, 98107, US

(21) Appl. No.: 12/660,059

(22) Filed: Feb. 20, 2010

Related U.S. Application Data
(60) Provisional application No. 61/208,156, filed on Feb. 20, 2009.

(51) Int. Cl. B05D 3/12; B05C 11/02

(52) U.S. Cl. 427/359; 118/100; 427/368

(57) ABSTRACT

A dip-coating system incorporates familiar materials into a totally unique configuration that provides users with a unique portable, environmentally friendly, cost effective and high quality coating application system for many liquid coating materials like stains and paints. Advantages of the dip-coating system vs. traditional coating application systems include:
Simple and fast one person set-up, operation and clean-up, resulting in very low cost of operations
Superior/Outstanding environmental sensitivity, facilitating environmentally conscious coating application even with high VOC coatings through an integrated excess coating material recycling, system
Vastly superior quality of coating results when compared to conventional methods
Elimination of most weather related constraints, with limited staging requirements, safe/clean indoor or small covered area application setting requirements

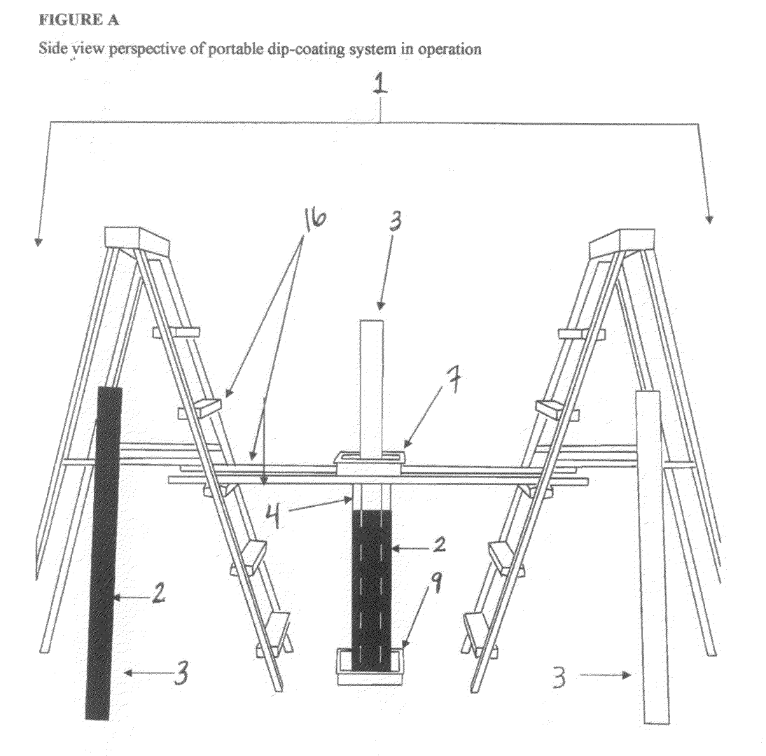

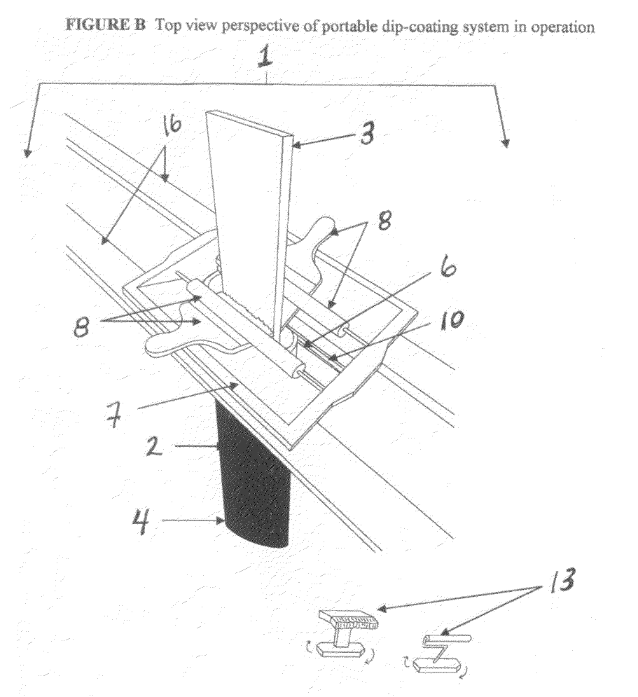

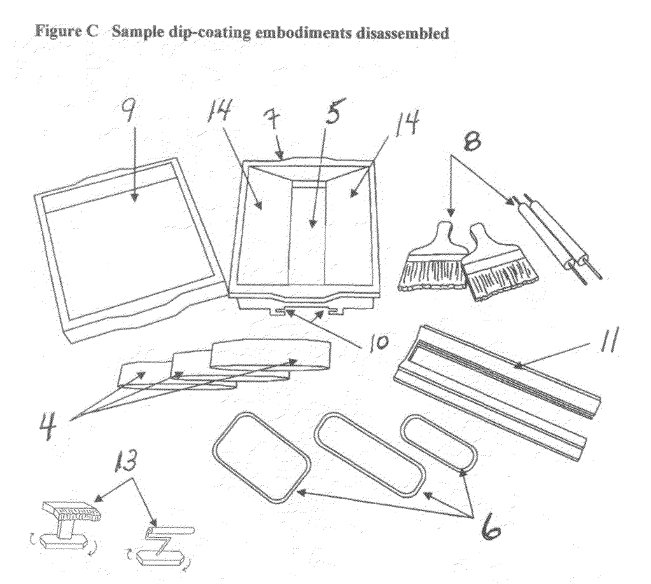

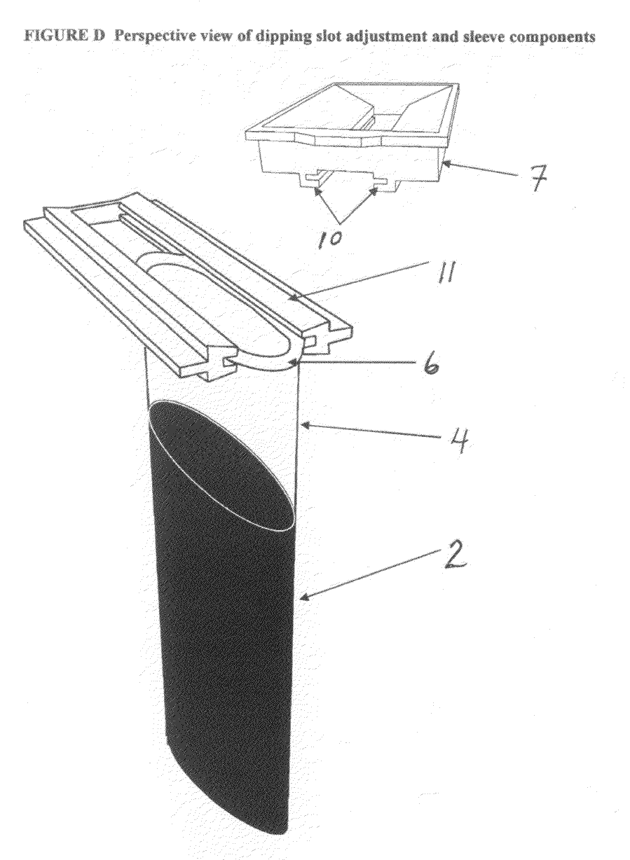

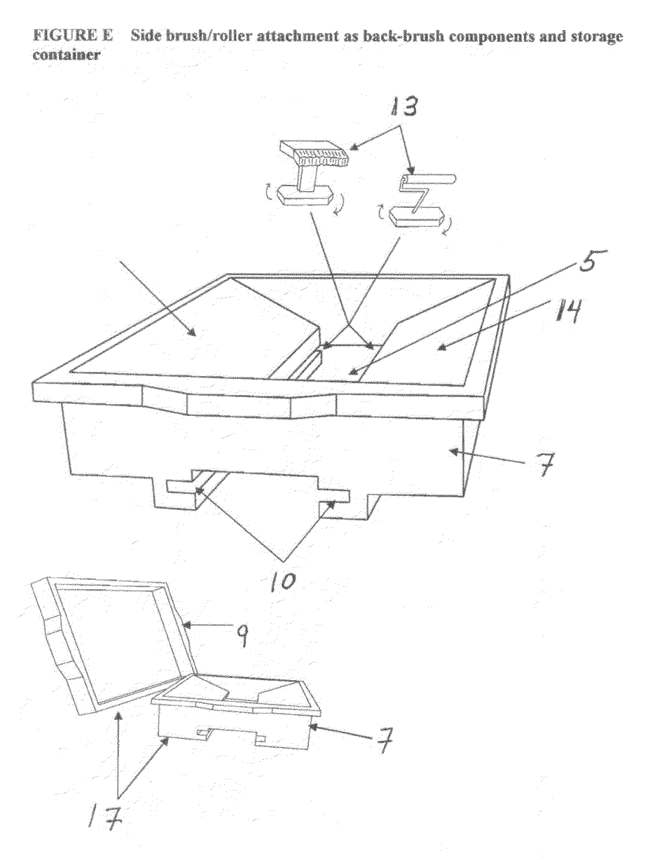

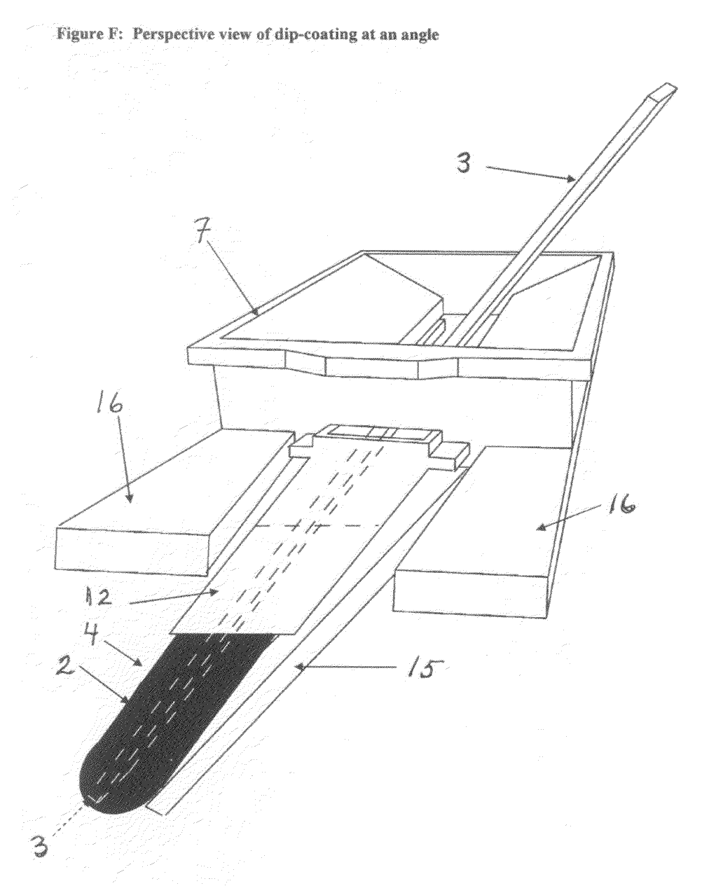

### BACKGROUND

Homeowners and building contractors have used liquid coating materials, such as stains and paints, to protect and beautify the surface of various building and construction materials (hereafter; building materials 3), such as wood, plastic and metal. In many circumstances building materials 3 are acquired unfinished, therefore requiring the application of protective and beautifying liquid coating materials (hereafter; liquid coating 2) either just prior to or post installation of a building material 3.

Current coating application systems include the use of manually operated paint brushes and paint rollers, as well as various forms of manually operated, electrically powered spraying devices. As prior art in the field of portable coating application systems, the current systems have significant negative environmental consequences, application environment constraints and limitations, high labor costs and significant quality control problems.

The negative environmental consequences of these traditional systems have given cause for the coating materials industry to modify coating composition. The coating materials industry, including stain and paint manufacturers have established standard to reduce Volatile Organic Compounds (VOC's) in their liquid coatings 3, which have proven most damaging to the environment. However, there are major tradeoffs in moving the coating materials industry away from high VOC content products. Professionals unanimously agree that substitute products under-perform VOC products in durability and life expectancy. The result is more repeated usage of non-VOC type products, which themselves are only less-toxic. The principle VOC problem is derived from the current portable liquid coating application systems. This is particularly obvious when spray application of liquid coating creates a mist of liquid and vapors absorbed into the air/atmosphere and covering adjacent surfaces surrounding the target building material surfaces including the persons performing the manual application process. Breathing protection devices are recommended when using these current application methods. Compounding the environmental problems, current systems require frequent cleaning and disposal of residual product and cleaning solvents. The subject dip-coating system 1, apparatus and method for applying liquid coating 2 have been created to overcome several of the worst problems associated with using current application systems whether VOC compounds or newer non-VOC liquid coatings, while simultaneously lowering application, preparation and clean-up costs, and dramatically improving the application quality of the liquid coating 2.

The shortcomings of traditional application systems fall into several categories:
Lack of environmental sensitivity
Poor quality in terms of thoroughness and consistency of applied coating
Lengthy time requirements for preparation, application and clean-up
Weather-limited liquid coating application constraints

### Spraying Deficiencies

Spraying has fundamental weaknesses.
1. Spraying creates an environmental hazard due to the inability to carefully control disbursement of the liquid/vapor spray. Tarp and tape covering requirements on any and all not-to-be-painted adjacent surfaces, reflects the excessive waste of coating product with this application system. Toxic chemicals, in both liquid and vapor form are released continuously into the air and surrounding environment and into the lungs and skin pores people spraying without proper breathing and garment protection.

2. Spraying has a poor quality of coating coverage. Disbursement of spray is hugely impacted by the distance from the spray nozzle to article and the pace or speed which the spray nozzle is wanded over the article surface. Too slow or too close wanding of the spray nozzle causes excessive application; too distant or too fast of wanding thins the coating to a mere color coat that washes off in rain exposure and bleaches off in sunshine. This is exacerbated when the surfaces being coated are thin or small, like board edges and ends, typically resulting in minimal or no coverage in these critical areas. For instance, fence boards are typically sprayed post-installation. The top and bottom ends of the boards are rarely accessible to sprayers due to height or ground proximity constraints, yet these ends are the most vulnerable to weather-based deterioration. While most spray system manufacturers recommended ‘back-brushing’ to achieve best penetration and saturation results, this recommendation is rarely executed and if executed, adds greatly to the application time and associated costs.
3. Spraying has extensive preparation time, extensive/expensive/environmentally unfriendly cleanup, and requires expensive equipment necessitating an on-site electrical power source. Exterior spraying has significant precipitation and temperature constraints, requiring days of dry/warm weather both pre and post application. Considering these major drawbacks to spraying, it still remains the predominant commercial builder coating application method.

### Brushing and Rolling Deficiencies

Brushing and rolling of coating liquids has significant sensitivity to the care given during the coating process; the greater the care, the greater the time spent during application, less care results in excessive product waste and poor quality of application. These methods require a significant staging area and are severely constrained by temperature and precipitation factors with exterior applications. Time and motion studies clearly define these methods as most costly in time required for application while providing inconsistent quality of application at best. These methods are most often used by consumers due to the expense and complexity of spraying equipment. Commercial builders use these methods on many interior applications like wall surfaces and trim work where spraying is problematical with multiple adjacent surfaces requiring tarp and tape protection, or where surfaces are small, requiring more exact application (interior trim work). Clean-up residue (liquid coating and cleaning solvent) is typically discarded into ground water or sewer systems, an environmental disaster when the numbers of incidences of these actions are considered across the painting population.

Dip coating systems and methods have been used for centuries to apply liquid coating materials to articles requiring such. Modern day prior art in dip coating devices and methods have been focused upon factory-like application environments, in many cases automated and mechanized systems. These systems take advantage of the thoroughness of application that dip coating provides and has recently evolved many ways to control VOCs and related kinds of vapors, minimizing their negative environmental impacts. Forgotten and unaddressed is the ability to easily implement dip coating systems remotely, away from a dipping-equipped facility, for instance, at a construction site. This forgotten market represents a very large segment of the coating application market. Spraying, brushing and rolling type devices and methods represent the only options for paints, stains, perservatives and like products for remote, on-job site applications. The remote application setting is a major environmental problem, without the control capabilities of a factory setting. There are no portable systems for construction-site liquid coating material application that are environmentally sensitive. For example, spray painting, the pre-dominant commercial method for exterior and many interior surfaces, like houses and fences, release an enormous amount of spray vapor into and onto the environment surrounding the target article. The means of the application method are only part of the problem. Clean-up procedures for these devices inevitably result in large amounts of coating residue and cleaning solvents being released into sewer and ground water systems with terrible consequences. The described innovation was developed to bring dip coating, including its cost-efficiency and thoroughness of coating, to remote locations; to the construction site. With environmentally superior attributes, the portable dip coating system facilitates coating and solvent recycling and thorough coating penetration on desired objects, not easily washed or sun-bleached off into the environmental with exposure. This attribute increases the mean time between re-coating or replacement. This innovation will significantly improve the efficiency and environmental problems historically associated with remote liquid coating application systems.

### SUMMARY

The subject innovative dip-coating system 1, and related method, as shown in typical embodiment in Figure A, incorporates familiar materials into a totally unique configuration that provides users with a unique portable, environmentally friendly, cost effective and high quality coating application system for many liquid coating materials like stains and paints. While the innovation has been illustrated and described in detailed drawings and descriptions, such should be considered as illustrative of general embodiments, not restrictive in character.

The subject portable dip-coating system 1 facilitates the coating/application process through submersion of a building material 3, like a fence board or deck railing, into a dipping sleeve 4, a plastic-type bag, tube or rectangular cylinder containing liquid coating 2. Sleeve 4, is larger in cross-sectional dimension and greater than 60% of the length of the building material 3 being dip-coated. The sleeve 4 is connected at the top, open cross-sectional end, to a funnel box 7 mounted above the sleeve 4. The funnel box 7 is supported by various mounting methods; one such typical embodiment of the funnel box support structure 16 is shown in Figure A. Building material 3, such as a fence board is inserted through a dipping slot 5 located in the bottom of the funnel box 7 into a sleeve 4. The building material 3 is inserted to a point where greater than 50% of the building material 3 becomes submerged in liquid coating 4. The building material 3 is then withdrawn from the sleeve 4 and funnel box 7, inverted 180 degrees and re-inserted into sleeve 4 to a point where 100% of the surface area of the building material 3 has been submersed into the liquid coating 2. Paint brushes, paint rollers or squeegee type devices are attached to the funnel box 7 above the dipping slot 5. The brush, roller or squeegee-type devices, (hereafter; back-brushing assembly 8), press the liquid coating 2 into the building material 3 as it is withdrawn from sleeve 4, facilitating exceptional penetration and consistency of liquid coating 2 onto and into the building material 3, while simultaneously performing a squeegee effect, recycling excess liquid coating 2 back into the sleeve 4, for re-use, resulting in little waste of liquid coating 2 as an environmental contaminate. This dip-coating system 1 results in a uniform coating to all sides of a building material 3 with minimal waste in vapor or liquid form. Advantages of the dip-coating system 1 vs. traditional coating application systems include:
Simple and fast one person set-up, operation and clean-up, resulting in very low cost of operations
Superior/Outstanding environmental sensitivity, facilitating environmentally conscious coating application even with high VOC coatings through an integrated excess coating material recycling system
Vastly superior quality of coating results when compared to conventional methods
Elimination of most weather related constraints, with limited staging requirements, safe/clean indoor or small covered area application setting requirements

The portable dip-coating system 1 has multiple forms of embodiment. Simple embodiments of the dip-coating system 1 facilitate dipping of a limited number of sizes of building material 3, for example fence boards, deck railings and trim. More versatile embodiments accommodate a broader range of building material 3 with more varied cross-sectional dimensions, like metal or wood fence posts and framing/structural lumber in addition to fence boards, deck rails and trim. A more versatile embodiment of the dip-coating system 1 is described herein. This described apparatus and method is not intended to limit the scope of embodiments requesting patent protection. Dimensional attributes of the apparatus can and should be adapted to the specific building materials 3 requiring application of a liquid coating 2. Generally the form factor of this portable apparatus, in storage, is similar in size to a one-handed tool box.

### BRIEF DESCRIPTION OF THE DRAWINGS

### Sample Embodiments

FIGURE A shows a side view perspective of portable dip-coating system in operation
1 side view perspective of portable dip-coating system
2 liquid coating material
3 building material (fence boards)
4 dipping sleeves
7 funnel box
9 funnel box cover
16 funnel box support structure (ladder and 2×4 horizontals)

FIGURE B shows a top view perspective of portable dip-coating system in operation
1 top view perspective of portable dip-coating system
2 liquid coating material
3 building material (fence boards)
4 dipping sleeves
6 collar(s)
7 funnel box
8 back-brushing assembly (brushes and rollers)
10 channel
13 side back-brush assembly embodiment
16 funnel box support structure (ladder and 2×4 horizontals)

FIGURE C shows sample dip-coating embodiments disassembled
1 dip-coating system components (disassembled)
4 dipping sleeves
5 dipping slot (in the dipping box)
6 collar(s)
7 funnel box
8 back-brushing assembly (brushes and rollers)
9 funnel box cover
10 channel
11 dipping slot reducer
13 side back-brush assembly embodiment
14 angled funnel box side walls

FIGURE D shows a perspective view of dipping slot adjustment and sleeve
2 liquid coating material
4 dipping sleeves
6 collar(s)
funnel box
10 channel
11 dipping slot reducer

FIGURE E shows side brush/roller back-brush components & storage container
5 dipping slot (in the dipping box)
7 funnel box
10 channel
13 side back-brush assembly embodiment
14 angled funnel box side walls
17 funnel box packaging system (funnel box and cover)

FIGURE F perspective view of dip-coating at an angle
2 liquid coating material
3 building material (fence boards)
4 dipping sleeves
7 funnel box
12 dipping slot angle adjuster
15 sleeve support board (holding the angled dipping sleeve)
16 funnel box support structure (ladder and 2×4 horizontals)

### DETAILED DESCRIPTION

The following describes an embodiment of a portable dip-coating system 1 (apparatus and method reflected in Figures A & B), used to apply liquid coating material 2 (hereafter; liquid coating) like paint and stain, to building and construction material 3 (hereafter; building material(s)).

The portable dip-coating system 1 includes a translucent dipping sleeve 4 (hereafter; sleeve), that attaches below a dipping slot 5, located in the bottom of funnel box 7, similar in nature to a one-handed toolbox. A sleeve 4 is attached below the dipping slot 5 with a collar 6. The sleeve 4 is filled with liquid coating 2. Building material 3 is inserted through the funnel box 7 dipping slot 5 into the liquid coating 2 filled sleeve 4. Located above the dipping slot 5 are paint brushes, paint rollers, squeegees or other scraping devices, herein referred to as the back-brushing assembly 8. As building material 3 is withdrawn from the filled sleeve 4 the back-brushing assembly 8 presses liquid coating 2 onto and into a dipped building material, recycling excess liquid coating 2 back into the sleeve 4.

In one embodiment, the funnel box (7) and funnel box cover (9) attributes are:
1. a portable secure package for storage, transport and retail display of the dip-coating system 1.
2.a dipping slot 5 in the bottom of the funnel box 7.
3.a channel 10 support system located below the dipping slot 5 for suspension of a sleeve (4) to be filled with liquid coating 2; typical sleeve 4 embodiments could be heavy duty plastic bags or a rigid plastic sleeve.
4. a channel 10, located below the dipping slot 5 that provides a support system for:
   a. collars 6 securing sleeves 4 to the funnel box 7; Collars have multiple possible embodiments. Collar 6, similar in nature to a standard hose clamp can be attached to the channel 10 from the exterior. Alternatively the channel 10 facilitates an interior channel 10, where a form fitting collar 6 can be inserted into the channel 10 as shown in one sample embodiment in Figures B, C & D.
   b. a dipping slot reducer changes the size of the dipping slot 5, shown in one embodiment as dipping slot reducer 11, allowing the dipping slot 5 to conform closely with the cross-sectional dimension of a building material 3.
   c. dipping slot angle adjuster 12 directs dipping (insertion of building material 2 at non-vertical angles. Non-vertical dipping accommodates long-length building material 2.
   d. Side back-brushes 13 as a component of the back-brushing assembly 8, provide back-brushing type function to 360 degrees (the full circumference) of a dipped building material 3.
5. In one embodiment, the funnel box 7 has interior angled side walls 14 for funneling liquid coating 2 into the dipping slot 5 and sleeve 4. The angled interior side walls 14 also provide a mounting surface for the back-brush assembly (8).

In one embodiment, a funnel box cover 9 (hereafter; cover) attaches securely to the funnel box 7, using any one of many traditional latching systems. Cover 9 is fully removable and water-tight container, that when placed below the funnel box 7 and sleeve 4 captures liquid coating 2 that could escape containment by the funnel box 7 and sleeve (4). Cover 9 as shown in Figure A, C & E is placed below sleeve 4 during dip-coating operations, providing an environmentally sensitive spill prevention system. The cover 9 is also a water/vapor barrier, placed over the funnel box 7 while the dip-coating system 1 is ready for operation, yet idle. This method of evaporation containment controls release of VOCs or similar hazardous, toxic vapors escaping into the atmosphere, while protecting the dip-coating system 1 from precipitation or other contamination to the coating material 2, yet permitting the dip-coating system 1 to remain fully assembled with coating material 2 held in the sleeve 4. In effect, the user can put the dip-coating system 1 ‘on-hold’ (even for days) without disassembly, minimizing clean-up requirements. Current spraying and brushing application systems requiring clean-up shortly (within hours of use) in order to preserve application apparatus' (brushes/rollers/sprayers) and protect liquid coating 2. Clean-up for traditional application methods is most always an environmentally disastrous event, as clean-up residue of liquid coating 2 and cleaning solvents are disposed of directly into ground water or sewer systems. The dip-coating system 1, distinguishes itself as an environmentally conscious system. Liquid coating 2 is closely contained within the dip-coating system . Only small amounts of cleaning solvent (+/− eight ounces) are required to clean a funnel box 7, back-brushing assembly 8 and sleeve 4. Solvents and liquid coating 2 residue are captured in the sleeve 4 during cleaning, then returned to permanent container storage, in effect, recycling the clean-up residues into the liquid coating 2. This attribute assumes use of cleaning solvents, compatible with liquid coating 2 applied; like paint thinner is compatible for mixing with many kinds of paints.

Sleeve 4 dimensions are relative to the dimension of the building material 3 being coated. Sleeve 4 length is generally, greater than 60% of the length of the building material 3, but less than 100%. The top, open end, of the sleeve 4 is larger than the cross-sectional dimension of the building material 3 being dipped. Sleeves 4 are made available in a variety of cross-sectional dimension sizes, for instance building lumber with cross-sectional dimensions like 4×4 inch, 2×8 inch or 1×1 inch . In one embodiment, the sleeve 4 is a reinforced/heavy duty translucent plastic bag capable of being folded for storage as shown in Figure C. Translucence in the sleeve 4 allows users to visually determine the depth of liquid coating 2, which is kept filled to a level to cover 50+% of the building material 3 length. As two example embodiments a plastic bag sleeve 4 may be either single layer or double layer. Sleeve 4 bag embodiments are typically a heavy mil poly/plastic bag (+/−6 mil). Sleeve 4 bag length can be customized in length by folding/rolling the top/open end of the sleeve 4 bag over a collar 6 until the desired length appropriate for the length of the building material 3 being dipped. In a different embodiment, the sleeve 4 is made of more-rigid plastic with translucent properties to allow visual determination of liquid coating 2 fill level. In the rigid plastic embodiment the collar 6 is incorporated into the open top end of the rigid plastic sleeve 4. A variety of pre-formed rigid sleeves accommodate a variety of building material 3 sizes.

The portable dip-coating system 1 facilitates angled dipping, which allows a sleeve 4 to be lengthened to accommodate long building materials 3, while allowing operational use by a person standing at ground level. For example, a 12 foot fence board would require a sleeve 4 of greater than six feet in length to achieve liquid coating 2 coverage of greater than 50% of length. If such a building material 3 were dipped in a vertical direction, the funnel box 7 would need to be located more than 6 feet above ground level. This height would make it difficult for an average person to dip while standing at ground level. By deploying the sleeve 4 downward at a non-vertical angle through use of the dipping slot angle adjuster 12, the funnel box 7 can remain at ground level operating height when dipping long building materials 3 as shown in Figure F.

In one embodiment the dipping slot angle adjuster 12 is used in conjunction with a dipping sleeve support board 15 (hereafter; sleeve support board). In one embodiment the sleeve support board 15 connects to a dip-coating system 1 support structure 16, which in one sample embodiment, consists of two common ladders with two horizontal 2×4 inch boards of at least several feet in length are positioned on equivalent height ladder rungs, with the dip-coating system 1 supported by the horizontal 2×4's as shown in Figure A. The sleeve support board 15 is connected to the dip-coating system support structure as shown in Figure F, using a conventional method of attachment like common screws. The sleeve support board 15 is of appropriate length, width and strength to support the length, width and weight of the sleeve 4 when filled with liquid coating 2.

Back-brush assembly 8 in separate embodiments can include typical paint brushes, paint rollers, squeegees or scraping devices mounted and attached inside the funnel box 7. The back-brush assembly 8 makes contact with building materials 3 as inserted and withdrawn from the sleeve 4 and funnel box 7, pressing liquid coating 2 onto and into building materials 3 removing air bubbles or foreign matter from the surface of the building material 3. Back-brushing assembly 8 also serves a ‘squeegee’ function, recycling excess coating material 2, pressing it down the building material 3 into the sleeve 4 as the article is withdrawn from the dip-coating system 1. In one embodiment the back-brush assembly is mounted inside the funnel box 7 on angled side walls 14, positioned over the dipping slot 5.

In one embodiment side brushes 13, are used as a part of the back-brushing assembly 8. Prior to dipping larger cross-sectional building materials 3, like 4 inch×4 inch fence posts, are dip-coated, side brushes 13, are installed by placing/twisting opposing ends of the side brush (handle end vs. brush end) 16 fitting into the channel 10 located on opposing sides of the dipping slot 5, providing back-brushing on 360 degrees of a dipped building material 3.

This unique portable dip-coating system 1 delivers a uniform liquid coating 2 coverage, provided a ‘wet edge’ is maintained on the building material 3 during dipping.

All sides of a dipped building material receive a thorough coating. For example, a fence-type board, shown as a typical building material 3 receives exceptional coverage via submersion into a liquid coating 2 exposing all six or more sides of a building material 3 including, importantly including ends and sides, to coating liquid 2. Current and traditional portable application methods of brushing, rolling and spraying rarely achieve consistent liquid coating 2 coverage, particularly inadequate on narrow sides and ends building materials 3. Achieving coverage on small surfaces with current systems generally results in significant waste of liquid coating 2, dispersed into our air and ground water systems, creating an environmental disaster. The magnitude of the pollution problem becomes apparent if you take the number of incidences of coating application events, the dominance of spraying as the preferred portable application method and spraying's disastrous environmental implications, particularly on exterior application surfaces. There is no portable application system in the market that provides an alternative to spraying, brushing or rolling.

### Coating Material Dipping Sleeve Packaging System

A dip-coating material packaging system 17, a sleeve 4 with a re-sealable top, provides an alternative packaging system for liquid coating 2, in contrast to paint can-type packaging. Said packaging 17 consists of a translucent sleeve 4, typical embodiments including a heavy duty, reinforced poly/plastic-type bag or a rigid plastic-type sleeve (a ‘sleeve’ of paint vs. a can of paint). Said packaging incorporates a collar 6 compatible with dip-coating system 1 funnel box 7. The dip-coating packaging system 17 can be further wrapped in an exterior protective layer, like a waxed cardboard box. The protection layer in one embodiment includes a translucent/transparent viewing surface to allow visual determination of depth of liquid coating 2 in the sleeve 4, thereby eliminating the need to remove the protective layer during dipping operations.

What is claimed is:

1. A portable dip-coating system for applying a liquid coating material to building and construction materials, the system comprising:
a dipping sleeve for holding a liquid coating material while a region of the building and construction material is dipped into the liquid coating material to coat the region of building and construction material with the liquid coating material;
a funnel box having:
a dipping slot through which the region of the building or construction material passes before entering the liquid coating material held in the dipping sleeve, and
a collar channel for fastening the dipping sleeve to the funnel box;
a dipping sleeve collar operable to fasten the dipping sleeve to the funnel box when inserted into the collar channel of the funnel box; and
a back-brushing or back-rolling component for pressing liquid coating material onto and into the region of the building and construction material that was dipped into the liquid coating material held in the dipping sleeve.

2. The portable dip-coating system of claim 1 wherein the dipping sleeve includes translucent material to allow visual determination of the amount of liquid coating material held in dipping sleeve.

3. The portable dip-coating system of claim 1 wherein the dipping slot of the funnel box is substantially rectangular.

4. The portable dip-coating system of claim 1 wherein the dipping slot of the funnel box is positioned in the center of the box.

5. The portable dip-coating system of claim 1 wherein the funnel box includes two opposing side walls that angle downward from two opposing edges of the box and toward the dipping slot.

6. The portable dip-coating system of claim 1 wherein the collar channel of the funnel box is positioned below the dipping slot and forms a “U” around the dipping slot.

7. The portable dip-coating system of claim 1 wherein the dipping sleeve collar is flexible.

8. The portable dip-coating system of claim 1 wherein the back-brushing or back-rolling component is releasably attached to the funnel box.

9. The portable dip-coating system of claim 1 wherein the back-brushing or back-rolling component uniformly presses liquid coating material onto and into the region of the building and construction material that was dipped into the liquid coating material held in the dipping sleeve.

10. The portable dip-coating system of claim 1 wherein the region of the building and construction material includes substantially all of the material's surface.

11. The portable dip-coating system of claim 1 wherein the back-brushing or back-rolling component is positionable to accommodate different sized building and construction materials.

12. The portable dip-coating system of claim 1 wherein the dipping slot is adjustable to accommodate different sized building and construction materials.

13. The portable dip-coating system of claim 1 wherein the back-brushing or back-rolling component includes at least one of the following a paint brush, a paint roller and a scrapper.

14. The portable dip-coating system of claim 1 wherein dipping slot includes an angle that is adjustable

15. The portable dip-coating system of claim 1 wherein the system is operable to be assembled for storage and/or transportation such that when so assembled the dipping slot functions as a carry handle.

16. The portable dip-coating system of claim 1 wherein the dipping sleeve is re-sealable.

17. A method for applying a liquid coating material to a building and construction material, the method comprising:
inserting a region of a building or construction material through a dipping slot of a funnel box, and into a dipping sleeve holding the liquid coating material;
withdrawing the region of the building or construction material back through the dipping slot; and
pressing, with a back-brushing or back-rolling component, the liquid coating material onto and into the region of the building and construction material.

18. The method of claim 17 further comprising attaching a dipping sleeve below the dipping slot of the funnel box.

19. The method of claim 17 further comprising filling the dipping sleeve with the liquid coating material to a depth of at least 50% of the length of the building or construction material to be coated.

20. The method of claim 17 further comprising:
inserting another region of the building or construction material through the dipping slot of the funnel box, and into the dipping sleeve holding the liquid coating material;
withdrawing the other region of the building or construction material back through the dipping slot; and
pressing, with a back-brushing or back-rolling component, the liquid coating material onto and into the other region of the building and construction material.
